(19) United States
(12) Patent Application Publication
(10) Pub. No.: US 2018/0026735 A1
(43) Pub. Date: Jan. 25, 2018

(54) METHOD, DEVICE, SYSTEM, AND STORAGE MEDIUM FOR IMPLEMENTING TIME SYNCHRONIZATION IN OPTICAL TRANSPORT NETWORK

(71) Applicant: Sanechips Technology Co., Ltd., Shanezhen, Guangdong (CN)

(72) Inventor: Zongzheng Chen, Shenzhen (CN)

(21) Appl. No.: 15/543,386

(22) PCT Filed: Jul. 14, 2015
(86) PCT No.: PCT/CN2015/083984

§ 371 Date: Aug. 23, 2017

(30) Foreign Application Priority Data
Jan. 16, 2015 (CN) 201510023621.6

(51) Int. Cl. H04J 3/06; H04L 7/00

(52) U.S. Cl. CPC H04J 3/0667; H04J 3/067; H04L 7/00; H04J 3/065; H04J 2203/0089; H04J 2203/0085

(57) ABSTRACT

A master device generates a time synchronization message, performs a first correction on a correction domain of the time synchronization message, and sends it including a first timestamp T1 to a slave device. The slave device performs a second correction on the correction domain of the time synchronization message, adds a second timestamp T2, generates a delay request message, performs a third correction on the correction domain of the delay request message, and sends to the master device the delay request message including a third timestamp T3. The master device performs a fourth correction on the correction domain of the delay request message, adds a fourth timestamp T4, sends to the slave device a delay response message including the correction domain of the delay request message subjected to the fourth correction and the fourth timestamp T4. The slave device performs time synchronization with the master device accordingly.

### TECHNICAL FIELD

The present disclosure relates to an Optical Transport Network (OTN) transmission technology, and in particular to a method, device, system, and computer storage medium for implementing time synchronization in an OTN.

### BACKGROUND

With the development of communication networks, the OTN predominates in transmission networks, and becomes a platform for bearing a variety of services. Many services have a high requirement on time synchronization. The OTN, as a main body for bearing services, is required to ensure a correct transfer of time synchronization protocols.

The IEEE 1588 protocol can provide time synchronization and frequency synchronization uniformly, and can be suitable for a method for interoffice time-frequency transportation among different transport platforms. The main concept of the protocol is using a master-slave clock to code time information, and using network symmetry and delay measurement technology to implement master-slave time synchronization through bidirectional interaction of messages. Thus, to implement high-precision 1588 time synchronization, the following two conditions are necessary: one is that transmission paths are symmetrical; and another is time deviations of main and slave nodes are stable and not allowed to change. If any one of the two conditions is not satisfied, the precision of synchronization is influenced greatly. In the OTN, since an OTN frame is encapsulated, mapped and coded, transmission time of the OTN is not a stable value. So, to implement a function of high-precision 1588 time synchronization in the OTN, unsymmetrical and unstable transmission delay is needed to be avoided.

### SUMMARY

In view of this, the embodiments of the present disclosure provide a method, device, system, and computer storage medium for implementing time synchronization in an OTN, which can eliminate an influence caused by asymmetry of an OTN delay and improve the precision of 1588 time synchronization.

To this end, the embodiments of the present disclosure are implemented as follows.

A method for implementing time synchronization in an OTN is provided, which includes that:

a master device generates a time synchronization message, performs a first correction on a correction domain of the time synchronization message, and sends to a slave device the time synchronization message including a first timestamp T1; and

the master device receives a delay request message which has been subjected to a third correction and includes a third timestamp T3, performs a fourth correction on a correction domain of the delay request message, adds a fourth timestamp T4 to the delay request message, and sends to the slave device a delay response message including the fourth timestamp T4 and the correction domain of the delay request message which has been subjected to the fourth correction.

In the above solution, the process that the master device generates the time synchronization message, performs the first correction on the correction domain of the time synchronization message, and sends to the slave device the time synchronization message including the first timestamp T1 includes that:

the master device includes a first time synchronization device and a first service transport device, wherein the first time synchronization device generates the time synchronization message, writes into the time synchronization message the first timestamp T1 at which the time synchronization message is generated, and adds to the correction domain of the time synchronization message a complement of local counting time t1 at which the time synchronization message exits from the first time synchronization device; the first service transport device receives the time synchronization message from the first time synchronization device, adds local counting time t2 at which the time synchronization message exits from the first service transport device to the correction domain of the time synchronization message, and sends the time synchronization message out.

In the above solution, the process that the master device performs the fourth correction on the correction domain of the delay request message, adds the fourth timestamp T4 to the delay request message, and sends to the slave device the delay response message including the fourth timestamp T4 and the correction domain of the delay request message which has been subjected to the fourth correction includes that:

the first service transport device sends local counting time t3 at which the delay request message is received as well as the delay request message to the first time synchronization device; the first time synchronization device determines local counting time t4 at which the delay request message is received, adds a difference value between t4 and t3 to the correction domain of the delay request message, generates the delay response message, adds to the delay response message the fourth timestamp T4 at which the delay response message is generated and the correction domain of the delay request message, and sends the delay response message to the slave device through the first service transport device.

In the above solution, the process that the master device sends the time synchronization message to the slave device includes that: the time synchronization message is inserted into reserved overhead of an OTN frame after being encapsulated by a Generic Framing Procedure-Framed (GFP-F); and the time synchronization message is sent to the slave device through the OTN frame.

A method for implementing time synchronization in an OTN is also provided, which includes that:

the slave device receives a time synchronization message which has been subjected to a first correction and includes a first timestamp T1, performs a second correction on a correction domain of the time synchronization message, and adds a second timestamp T2 to the time synchronization message;

the slave device generates a delay request message, performs a third correction on a correction domain of the delay request message, and sends to a master device the delay request message including the third timestamp T3; and

the slave device receives a delay response message including a fourth timestamp T4 and the correction domain of the delay request message which has been subjected to a fourth correction, and performs time synchronization with the master device according to the T1, the T2, the T3, the T4, the correction domain of the time synchronization message, and the correction domain of the delay request message.

In the above solution, the process that the slave device receives the time synchronization message which has been subjected to the first correction and includes the first timestamp T1, performs the second correction on the correction domain of the time synchronization message, and adds the second timestamp T2 to the time synchronization message includes that:

the slave device includes a second time synchronization device and a second service transport device, wherein the second service transport device receives the time synchronization message which has been subjected to the first correction and includes the first timestamp T1, and sends local counting time t5 at which the time synchronization message is received as well as the time synchronization message to the second time synchronization device; the second time synchronization device determines local counting time t6 at which the time synchronization message is received, adds a difference value between t6 and t5 to the correction domain of the time synchronization message, and adds to the time synchronization message the second timestamp T2 at which the time synchronization message is received.

In the above solution, the process that the slave device generates the delay request message, performs the third correction on the correction domain of the delay request message, and sends to the master device the delay request message including the third timestamp T3 includes that:

the second time synchronization device generates the delay request message, writes into the delay request message the third timestamp T3 at which the delay request message is generated, and adds a complement of local counting time t7 at which the delay request message exits from the second time synchronization device to the correction domain of the delay request message; and the second service transport device receives the delay request message from the second time synchronization device, adds local counting time t8 at which the delay request message exits from the second service transport device to the correction domain of the time synchronization message, and sends the delay request message out.

A method for implementing time synchronization in an OTN is also provided, which includes that:

a master device generates a time synchronization message, performs a first correction on a correction domain of the time synchronization message, and sends to a slave device the time synchronization message including a first timestamp T1;

the slave device performs a second correction on the correction domain of the time synchronization message, and adds a second timestamp T2 to the time synchronization message;

the slave device generates a delay request message, performs a third correction on a correction domain of the delay request message, and sends to the master device the delay request message including a third timestamp T3;

the master device performs a fourth correction on the correction domain of the delay request message, adds a fourth timestamp T4 to the delay request message, and sends to the slave device the delay response message including the fourth timestamp T4 and the correction domain of the delay request message which has been subjected to the fourth correction;

the slave device performs time synchronization with the master device according to the T1, the T2, the T3, the T4, the correction domain of the time synchronization message, and the correction domain of the delay request message.

A master device is also provided, which includes a first time synchronization device and a first service transport device, wherein

the first time synchronization device is arranged to generate the time synchronization message, write into the time synchronization message the first timestamp T1 at which the time synchronization message is generated, and add to the correction domain of the time synchronization message the complement of local counting time t1 at which the time synchronization message exits from the first time synchronization device; the first time synchronization device is further arranged to determine local counting time t4 at which the delay request message is received, add to the correction domain of the delay request message a difference value between t4 and local counting time t3 at which the first service transport device receives the delay request message, generate a delay response message, add the fourth timestamp T4 at which the delay response message is generated and the correction domain of the delay request message to the delay response message, and send the delay response message to a slave device through the first service transport device; and

the first service transport device is arranged to receive the time synchronization message from the first time synchronization device, add local counting time t2 at which the time synchronization message exits from the first service transport device to the correction domain of the time synchronization message, and send the time synchronization message out; the first service transport device is further arranged to receive the time synchronization message which has been subjected to a correction performed by the slave device and includes a third timestamp T3, and send the local counting time t3 at which the delay request message is received as well as the delay request message to the first time synchronization device.

In the above solution, the first time synchronization device and the first service transport device each includes a local time counter; the local time counter of the first time synchronization device is arranged to generate the local counting time t1 and the local counting time t4, and the local time counter of the first service transport device is arranged to generate the local counting time t2 and the local counting time t3.

A slave device is also provided, which includes a second time synchronization device and a second service transport device; wherein

the second service transport device is arranged to receive a time synchronization message which has been subjected to a correction performed by a master device and includes a first timestamp T1, send local counting time t5 at which the time synchronization message is received as well as the time synchronization message to the second time synchronization device; the second service transport device is further arranged to receive a delay request message from the second time synchronization device, add local counting time t8 at which the delay request message exits from the second service transport device to a correction domain of the time synchronization message, send the delay request message out, and receive a delay response message including a fourth timestamp T4 and a correction domain of the delay request message which has been subjected to a correction performed by the master device; and

the second time synchronization device is arranged to determine local counting time t6 at which the time synchronization message is received, add a difference value between t6 and t5 to the correction domain of the time synchronization message, and add to the time synchronization message a second timestamp T2 at which the time synchronization message is received; the second time synchronization device is further arranged to generate the delay request message, write into the delay request message a third timestamp T3 at which the delay request message is generated, add a complement of local counting time t7 at which the delay request message exits from the second time synchronization device to the correction domain of the delay request message, and perform time synchronization with the master device according to the T1, the T2, the T3, the T4, the correction domain of the time synchronization message and the correction domain of the delay request message.

In the above solution, the second time synchronization device and the second service transport device each includes a local time counter; the local time counter of the second time synchronization device is arranged to generate the local counting time t6 and the local counting time t7, and the local time counter of the second service transport device is arranged to the local counting time t5 and the local counting time t8.

A system for implementing time synchronization in an OTN is also provided, which includes a master device and a slave device; wherein

the master device is arranged to generate a time synchronization message, perform a first correction on a correction domain of the time synchronization message, and send to a slave device the time synchronization message including a first timestamp T1; the master device is further arranged to receive a delay request message which has been subjected to a third correction and includes a third timestamp T3, perform a fourth correction on a correction domain of the delay request message, add a fourth timestamp T4 to the delay request message, and send to the slave device a delay response message including the fourth timestamp T4 and the correction domain of the delay request message which has been subjected to a fourth correction; and

the slave device is arranged to receive the time synchronization message which has been subjected to the first correction and includes the first timestamp T1, perform a second correction on the correction domain of the time synchronization message, and add a second timestamp T2 to the time synchronization message; the slave device is further arranged to generate the delay request message, perform the third correction on the correction domain of the delay request message, and send to the master device the delay request message including the third timestamp T3; the slave device is further arranged to receive the delay response message including the fourth timestamp T4 and the correction domain of the delay request message which has been subjected to the fourth correction, and perform time synchronization with the master device according to the T1, the T2, the T3, the T4, the correction domain of the time synchronization message and the correction domain of the delay request message.

A computer storage medium is also provided, having stored therein computer executable instructions for implementing any one of the methods for implementing time synchronization in an OTN as described above.

According to the method, device, system, and computer storage medium for implementing time synchronization in an OTN provided in the embodiments of the present disclosure, a master device generates a time synchronization message, performs a first correction on a correction domain of the time synchronization message, sends to a slave device the time synchronization message including a first timestamp T1; the slave device performs a second correction on the correction domain of the time synchronization message, and adds a second timestamp T2 to the time synchronization message; the slave device generates a delay request message, performs a third correction on a correction domain of the delay request message, and sends to the master device the delay request message including a third timestamp T3; the master device performs a fourth correction on the correction domain of the delay request message, adds a fourth timestamp T4 to the delay request message, sends to the slave device a delay response message including the fourth timestamp T4 and the correction domain of the delay request message which has been subjected to the fourth correction; the slave device performs time synchronization with the master device according to T1, T2, T3, T4, the correction domain of the time synchronization message, and the correction domain of the delay request message. In such a manner, an influence caused by asymmetry of an OTN delay can be eliminated, and the precision of 1588 time synchronization can be improved.

### BRIEF DESCRIPTION OF DRAWINGS

FIG. 1 is a schematic flowchart of a method for implementing time synchronization in an OTN provided in embodiment 1 of the present disclosure;

FIG. 2 is a schematic flowchart of a method for implementing time synchronization in an OTN provided in embodiment 2 of the present disclosure;

FIG. 3 is a schematic flowchart of a method for implementing time synchronization in an OTN provided in embodiment 3 of the present disclosure;

FIG. 4 is a schematic diagram of structure of a master device provided in embodiment 4 of the present disclosure;

FIG. 5 is a schematic diagram of structure of a slave device provided in embodiment 5 of the present disclosure; and

FIG. 6 is a schematic diagram of structure of a system for implementing time synchronization in an OTN provided in embodiment 6 of the present disclosure.

### DETAILED DESCRIPTION

In the embodiments of the present disclosure, a master device generates a time synchronization message, performs a first correction on a correction domain of the time synchronization message, and sends to a slave device the time synchronization message including a first timestamp T1; the slave device performs a second correction on the correction domain of the time synchronization message, and adds a second timestamp T2 to the time synchronization message. The slave device generates a delay request message, performs a third correction on a correction domain of the delay request message, and sends to the master device the delay request message including a third timestamp T3. The master device performs a fourth correction on the correction domain of the delay request message, adds a fourth timestamp T4 to the delay request message, sends to the slave device a delay response message including the fourth timestamp T4 and the correction domain of the delay request message which has been subjected to the fourth correction. The slave device performs time synchronization with the master device according to T1, T2, T3, T4, the correction domain of the time synchronization message, and the correction domain of the delay request message.

The present disclosure is further elaborated below based on accompanying drawings and specific embodiments.

### Embodiment 1

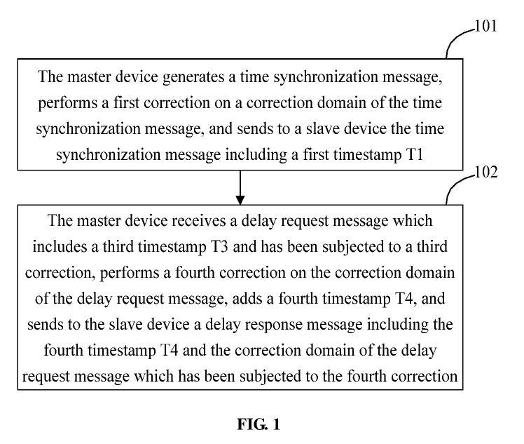

The embodiment of the present embodiment provides a method for implementing time synchronization in an OTN. As shown in FIG. 1, the method includes the following steps.

In step 101, a master device generates a time synchronization message, performs a first correction on a correction domain of the time synchronization message, and sends the time synchronization message including a first timestamp T1 to a slave device.

In an implementation, the master device includes a first time synchronization device and a first service transport device. The first time synchronization device generates the time synchronization message, writes into the time synchronization message the first timestamp T1 at which the time synchronization message is generated, and adds to the correction domain of the time synchronization message a complement of local counting time t1 at which the time synchronization message exits from the first time synchronization device. The first service transport device receives the time synchronization message from the first time synchronization device, adds, to the correction domain of the time synchronization message, local counting time t2 at which the time synchronization message exits from the first service transport device, and sends the time synchronization message out. Here, the local counting time t1 is the time indicated by a local time counter in the first time synchronization device, and the local counting time t2 is the time indicated by a local time counter in the first service transport device.

Sending the time synchronization message to the slave device may be inserting the time synchronization message into reserved overhead of an OTN frame after the time synchronization message is encapsulated by a Generic Framing Procedure-Framed (GFP-F), and sending the time synchronization message to the slave device through the OTN frame.

In step 102, the master device receives the delay request message which has been subjected to a third correction and includes a third timestamp T3, performs a fourth correction on a correction domain of the delay request message, adds a fourth timestamp T4 to the delay request message, and sends to the slave device the delay response message including the fourth timestamp T4 and the correction domain of the delay request message which has been subjected to a fourth correction.

In an implementation, the first service transport device receives the delay request message which includes the third timestamp T3 and has been subjected to the third correction, sends the local counting time t3 at which the delay request message is received as well as the delay request message to the first time synchronization device; the first time synchronization device determines local counting time t4 at which the delay request message is received, adds a difference value between t4 and t3 to the correction domain of the delay request message, generates the delay response message, adds the fourth timestamp T4 at which the delay response message is generated and the correction domain of the delay request message to the delay response message, and sends the delay response message to the slave device through the first service transport device. Here, the local counting time t3 is the time indicated by the local time counter in the first service transport device, and the local counting time t4 is the time indicated by the local time counter in the first time synchronization device.

Both the first timestamp T1 and the fourth timestamp T4 may be external GPS time of the master device, or the time of other accurate time source, or the synchronization time in the OTN. The third timestamp T3 may be the clock time of the slave device itself.

### Embodiment 2

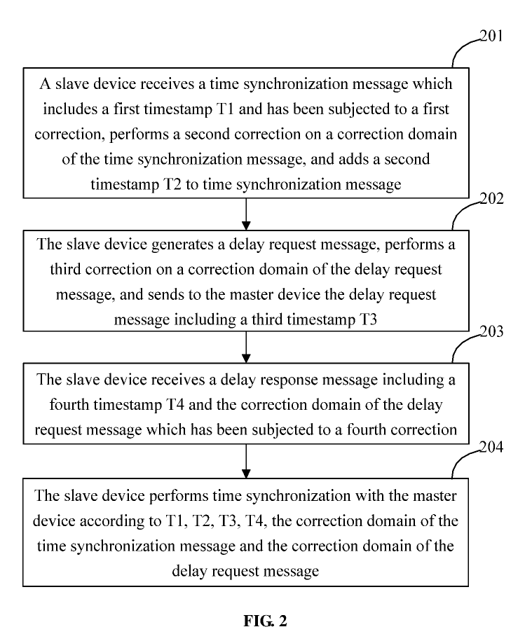

The embodiment of the present embodiment provides a method for implementing time synchronization in an OTN. As shown in FIG. 2, the method includes the following steps.

In step 201, a slave device receives a time synchronization message which has been subjected to a first correction and includes a first timestamp T1, performs a second correction on a correction domain of the time synchronization message, and adds a second timestamp T2 to the time synchronization message.

In an implementation, the slave device includes a second time synchronization device and a second service transport device, The second service transport device receives the time synchronization message which has been subjected to the first correction and includes the first timestamp T1, and sends local counting time t5 at which the time synchronization message is received as well as the time synchronization message to the second time synchronization device. The second time synchronization device determines local counting time t6 at which the time synchronization message is received, adds a difference value between t6 and t5 to the correction domain of the time synchronization message, and adds to the time synchronization message the second timestamp T2 at which the time synchronization message is received. Here, the local counting time t5 is the time indicated by the local time counter in the second service transport device, and the local counting time t6 is the time indicated by the local time counter in the second time synchronization device.

In step 202, the slave device generates a delay request message, performs a third correction on a correction domain of the delay request message, and sends to the master device the delay request message including a third timestamp T3.

In an implementation, the second time synchronization device generates the delay request message, writes into the delay request message the third timestamp T3 at which the delay request message is generated, and adds the complement of local counting time t7 at which the delay request message exits from the second time synchronization device to the correction domain of the delay request message. The second service transport device receives the delay request message from the second time synchronization device, adds local counting time t8 at which the delay request message exits from the second service transport device to the correction domain of the time synchronization message, and sends the delay request message out. Here, the local counting time t7 is the time indicated by the local time counter in the second time synchronization device, and the local counting time t8 is the time indicated by the local time counter in the second service transport device.

In step 203, the slave device receives the delay response message including the fourth timestamp T4 and the correction domain of the delay request message which has been subjected to the fourth correction.

In step 204, the slave device performs time synchronization with the master device according to T1, T2, T3, T4, the correction domain of the time synchronization message, and the correction domain of the delay request message.

In an implementation, the slave device obtains a time deviation between the master device and the slave device according to a formula: [(T2-T1-correction domain of time synchronization message)−(T4-T3-correction domain of delay request message)]/2. The slave device adds the time deviation to the time of the slave device to synchronize the slave device with the master device. The correction domain of the time synchronization message is the one on which the second correction has been performed, and the correction domain of the delay request message is the one on which the fourth correction has been performed.

### Embodiment 3

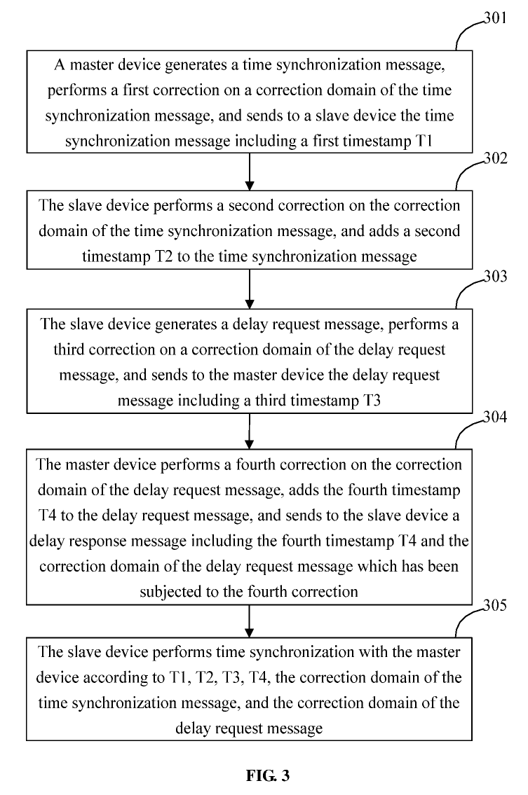

The embodiments of the present embodiment provides a method for implementing time synchronization in an OTN. As shown in FIG. 3, the method includes the following steps.

In step 301, a master device generates a time synchronization message, performs a first correction on a correction domain of the time synchronization message, and sends to a slave device the time synchronization message including a first timestamp T1.

In step 302, the slave device performs a second correction on the correction domain of the time synchronization message, and adds a second timestamp T2 to the time synchronization message.

In step 303, the slave device generates a delay request message, performs a third correction on a correction domain of the delay request message, and sends to the master device the delay request message including the third timestamp T3.

In step 304, the master device performs a fourth correction on the correction domain of the delay request message, adds a fourth timestamp T4 to the delay request message, and sends to the slave device the delay response message including the fourth timestamp T4 and the correction domain of the delay request message which has been subjected to the fourth correction.

In step 305, the slave device performs time synchronization with the master device according to T1, T2, T3, T4, the correction domain of the time synchronization message, and the correction domain of the delay request message.

### Embodiment 4

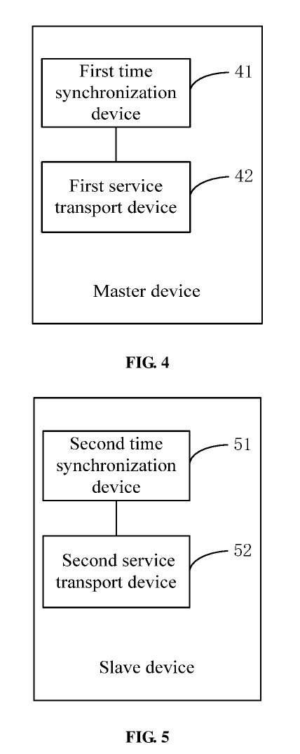

The embodiment of the present embodiment provides a master device. As shown in FIG. 4, the master device includes: a first time synchronization device 41 and a first service transport device 42.

The first time synchronization device 41 is arranged to generate a time synchronization message, write into the time synchronization message a first timestamp T1 at which the time synchronization message is generated, and add, to a correction domain of the time synchronization message, a complement of local counting time t1 at which the time synchronization message exits from the first time synchronization device 41. The first time synchronization device is further arranged to determine local counting time t4 at which a delay request message is received, add to the correction domain of the delay request message a difference value between t4 and local counting time t3 at which the first service transport device 42 receives the delay request message, generate a delay response message, add a fourth timestamp T4 at which the delay response message is generated and the correction domain of the delay request message to the delay response message, and send the delay response message to the slave device through the first service transport device 42.

The first service transport device 42 is arranged to receive the time synchronization message from the first time synchronization device 41, add to the correction domain of the time synchronization message local counting time t2 at which the time synchronization message exits from the first service transport device 42, and send the time synchronization message out. The first service transport device is further arranged to receive the time synchronization message which includes the third timestamp T3 and has been subjected to a correction performed by the slave device, and send to the first time synchronization device 41 the local counting time t3 at which the delay request message is received as well as the delay request message.

The first time synchronization device 41 and the first service transport device 42 each includes a local time counter. The local time counter of the first time synchronization device 41 is arranged to generate the local counting time t1 and the local counting time t4 of the first time synchronization device 41. The local time counter of the first service transport device 42 is arranged to generate the local counting time t2 and the local counting time t3 of the first service transport device 42.

Both the first timestamp T1 and the fourth timestamp T4 may be external GPS time of the master device, or the time of other accurate time source, or the synchronization time in the OTN. The third timestamp T3 may be the clock time of the slave device itself.

In practical applications, both the first time synchronization device 41 and the first service transport device 42 may be realized by a Central Processing Unit (CPU), a Micro Processor Unit (MPU), a Digital Signal Processor (DSP), or a Field Programmable Gate Array (FPGA) in the master device.

### Embodiment 5

The embodiment of the present embodiment provides a slave device. As shown in FIG. 5, the slave device includes a second time synchronization device 51 and a second service transport device 52.

The second service transport device 52 is arranged to receive a time synchronization message which includes a first timestamp T1 and has been subjected to a correction performed by the master device, and send, to the second time synchronization device 51, local counting time t5 at which the time synchronization message is received as well as the time synchronization message. The second service transport device 52 is further arranged to receive a delay request message from the second time synchronization device 51, add, to the correction domain of the time synchronization message, local counting time t8 at which the delay request message exits from the second service transport device 52, send the delay request message out, and receive a delay response message including the fourth timestamp T4 and the correction domain of the delay request message on which the master device has performed correction.

The second time synchronization device 51 is arranged to determine local counting time t6 at which the time synchronization message is received, add a difference value between t6 and t5 to the correction domain of the time synchronization message, and add to the time synchronization message a second timestamp T2 at which the time synchronization message is received. The second time synchronization device is further arranged to generate the delay request message, write into the delay request message a third timestamp T3 at which the delay request message is generated, add the complement of local counting time t7 at which the delay request message exits from the second time synchronization device 51 to the correction domain of the delay request message, and perform time synchronization with the master device according to T1, T2, T3, T4, the correction domain of the time synchronization message, and the correction domain of the delay request message.

The second time synchronization device 51 and the second service transport device 52 each includes a local time counter. The local time counter of the second time synchronization device 51 is arranged to generate the local counting time t6 and the local counting time t7 of the second time synchronization device 51. The local time counter of the second service transport device 52 is arranged to generate the local counting time t5 and the local counting time t8 of the second service transport device 52.

Both the first timestamp T1 and the fourth timestamp T4 may be external GPS time of the master device, or the time of other accurate time source, or the synchronization time in the OTN; the third timestamp T3 can be clock time of the slave device itself.

In practical applications, both the second time synchronization device 51 and the second service transport device 52 may be realized by a CPU, an MPU, a DSP or a FPGA in the slave device.

### Embodiment 6

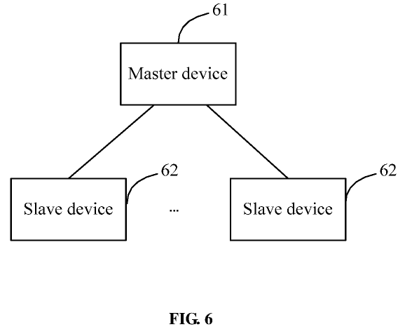

The embodiment of the present embodiment provides a system for implementing time synchronization in an OTN. As shown in FIG. 6, the system includes a master device 61 and a slave device 62.

The master device 61 is arranged to generate a time synchronization message, perform a first correction on a correction domain of the time synchronization message, and send to the slave device 62 the time synchronization message including a first timestamp T1. The master device is further arranged to receive a delay request message which includes a third timestamp T3 and has been subjected to a third correction, perform a fourth correction on a correction domain of the delay request message, add a fourth timestamp T4 to the delay request message, and send to the slave device 62 a delay response message including the fourth timestamp T4 and the correction domain of the delay request message which has been subjected to the fourth correction.

The slave device 62 is arranged to receive the time synchronization message which has been subjected to the first correction and includes the first timestamp T1, perform a second correction on the correction domain of the time synchronization message, and add a second timestamp T2 to the time synchronization message. The slave device is further arranged to generate the delay request message, perform the third correction on the correction domain of the delay request message, and send to the master device the delay request message including the third timestamp T3. The slave device is further arranged to receive the delay response message including the fourth timestamp T4 and the correction domain of the delay request message which has been subjected to the fourth correction, and perform time synchronization with the master device according to T1, T2, T3, T4, the correction domain of the time synchronization message, and the correction domain of the delay request message.

FIG. 4 illustrates the structure of the master device 61 which includes the first time synchronization device 41 and the first service transport device 42.

FIG. 5 illustrates the structure of the slave device 62 which includes the second time synchronization device 51 and the second service transport device 52.

To sum up, as described in the present disclosure, time synchronization can be realized between a slave device and a master device by determining the OTN time at which a time synchronization message and a delay request message enter and exit from the master device and the slave device, thereby eliminating an influence caused by asymmetry of an OTN delay and improving the precision of 1588 time synchronization.

An embodiment of the present disclosure also provides a computer storage medium, in which a computer program is stored. The computer program is used for performing the method for implementing time synchronization in an OTN shown in FIG. 1, or FIG. 2, or FIG. 3.

Those skilled in the art should appreciate that the embodiments of the present disclosure may be provided as a method, a system or a computer program product. The embodiments of the present disclosure may be in forms of full hardware, full software, or combination of software and hardware. Besides, the embodiments of the present disclosure may be in the form of a computer program product which is implemented on one or more computer readable storage media including computer executable program codes. The storage media include, but are not limited to, a magnetic disk memory and a Compact Disc-ROM (CD-ROM).

The present disclosure is described according to the flowcharts and/or block diagrams of the method, the device (system) and the computer program product in the embodiments of the present disclosure. It is to be understood that each flow and/or block in the flowchart and/or block diagram, and the combination of the flow and/or block in the flowchart and/or block diagram can be implemented by the computer program instructions. These computer program instructions can be provided to the processing unit of a general-purpose computer, a special-purpose computer, an embedded processor or other programmable data processing equipment to generate a machine, so that instructions which are executable by the processing unit of the computer or other programmable data processing equipment may generate a device which is arranged to implement specified functions in one or more flows of a flowchart and/or one or more blocks of a block diagram.

These computer program instructions may also be stored in a computer-readable memory which can guide the computer or other programmable data processing equipment to work in a particular way, so that the instructions stored in the computer-readable memory can generate a product including an instruction device. The instruction device implements the specified functions in one or more flows of the flowchart and/or one or more blocks of the block diagram.

These computer program instructions may also be loaded on a computer or other programmable data processing equipment, so that a series of operation steps are performed on the computer or other programmable data processing equipment to generate the processing which may be implemented by the computer, and the instructions executed on the computer or other programmable data processing equipment may provide the steps for implementing the specified functions in one or more flows of the flowchart and/or one or more blocks of the block diagram.

The above are only embodiments of the present disclosure and not intended to limit the scope of protection of the present disclosure. Any modifications, equivalent replacements and improvements within the spirit and principle of the present disclosure shall fall within the scope of protection of the present disclosure.

### INDUSTRIAL APPLICABILITY

In the embodiments of the present disclosure, a master device generates a time synchronization message, performs a first correction on a correction domain of the time synchronization message, and sends to a slave device the time synchronization message including a first timestamp T1. The slave device performs a second correction on the correction domain of the time synchronization message, and adds a second timestamp T2 to the time synchronization message. The slave device generates a delay request message, performs a third correction on the correction domain of the delay request message, and sends to the master device the delay request message including a third timestamp T3. The master device performs a fourth correction on the correction domain of the delay request message, adds a fourth timestamp T4 to the delay request message, sends to the slave device a delay response message including the fourth timestamp T4 and the correction domain of the delay request message which has been subjected to the fourth correction. The slave device performs time synchronization with the master device according to T1, T2, T3, T4, the correction domain of the time synchronization message, and the correction domain of the delay request message. In such a manner, an influence caused by asymmetry of an OTN delay can be eliminated, and the precision of 1588 time synchronization can be improved.

1. A method for implementing time synchronization in an Optical Transport Network (OTN), comprising:
generating, by a master device, a time synchronization message, performing a first correction on a correction domain of the time synchronization message, and sending to a slave device the time synchronization message including a first timestamp T1; and
receiving, by the master device, a delay request message which has been subjected to a third correction and includes a third timestamp T3, performing a fourth correction on a correction domain of the delay request message, adding a fourth timestamp T4 to the delay request message, and sending to the slave device a delay response message including the fourth timestamp T4 and the correction domain of the delay request message which has been subjected to the fourth correction.

2. The method according to claim 1, wherein generating, by the master device, the time synchronization message, performing the first correction on the correction domain of the time synchronization message, and sending to the slave device the time synchronization message including the first timestamp T1 comprises:
the master device comprises a first time synchronization device and a first service transport device, wherein the first time synchronization device generates the time synchronization message, writes into the time synchronization message the first timestamp T1 at which the time synchronization message is generated, and adds to the correction domain of the time synchronization message a complement of local counting time t1 at which the time synchronization message exits from the first time synchronization device; the first service transport device receives the time synchronization message from the first time synchronization device, adds, to the correction domain of the time synchronization message, local counting time t2 at which the time synchronization message exits from the first service transport device, and sends the time synchronization message out.

3. The method according to claim 2, wherein performing the fourth correction on the correction domain of the delay request message, adding the fourth timestamp T4 to the delay request message, and sending to the slave device the delay response message including the correction domain of the delay request message on which the fourth correction has been performed and including the fourth timestamp T4 comprises:
sending, by the first service transport device, local counting time t3 at which the delay request message is received as well as the delay request message to the first time synchronization device; and
determining, by the first time synchronization device, local counting time t4 at which the delay request message is received, adding a difference value between t4 and t3 to the correction domain of the delay request message, generating the delay response message, adding to the delay response message the fourth timestamp T4 at which the delay response message is generated and the correction domain of the delay request message, and sending the delay response message to the slave device through the first service transport device.

4. The method according to claim 1, wherein sending the time synchronization message to the slave device comprises:
inserting the time synchronization message into reserved overhead of an OTN frame after encapsulating the time synchronization message by a Generic Framing Procedure-Framed (GFP-F), and sending the time synchronization message to the slave device through the OTN frame.

5. A method for implementing time synchronization in an Optical Transport Network (OTN), comprising:
receiving, by a slave device, a time synchronization message which has been subjected to a first correction and includes a first timestamp T1, performing a second correction on a correction domain of the time synchronization message, and adding a second timestamp T2 to the time synchronization message;
generating, by the slave device, a delay request message, performing a third correction on a correction domain of the delay request message, and sending to a master device the delay request message including a third timestamp T3;
receiving, by the slave device, a delay response message including a fourth timestamp T4 and the correction domain of the delay request message which has been subjected to a fourth correction; and
performing, by the slave device, time synchronization with the master device according to the T1, the T2, the T3, the T4, the correction domain of the time synchronization message and the correction domain of the delay request message.

6. The method according to claim 5, wherein receiving, by the slave device, the time synchronization message which has been subjected to the first correction and includes the first timestamp T1, performing the second correction on the correction domain of the time synchronization message, and adding the second timestamp T2 to the time synchronization message comprises:
the slave device comprises a second time synchronization device and a second service transport device, wherein the second service transport device receives the time synchronization message which has been subjected to the first correction and includes the first timestamp T1, and sends local counting time t5 at which the time synchronization message is received as well as the time synchronization message to the second time synchronization device; the second time synchronization device determines local counting time t6 at which the time synchronization message is received, adds a difference value between t6 and t5 to the correction domain of the time synchronization message, and adds to the time synchronization message the second timestamp T2 at which the time synchronization message is received.

7. The method according to claim 6, wherein generating, by the slave device, the delay request message, performing the third correction on the correction domain of the delay request message, and sending to the master device the delay request message including the third timestamp T3 comprises:
generating, by the second time synchronization device, the delay request message, writing into the delay request message the third timestamp T3 at which the delay request message is generated, and adding a complement of local counting time t7 at which the delay request message exits from the second time synchronization device to the correction domain of the delay request message; and
receiving, by the second service transport device, the delay request message from the second time synchronization device, adding local counting time t8 at which the delay request message exits from the second service transport device to the correction domain of the time synchronization message, and sending the delay request message out.

8. (canceled)

9. A master device, comprising: a first time synchronization device and a first service transport device, wherein
the first time synchronization device is arranged to generate a time synchronization message, write into the time synchronization message a first timestamp T1 at which the time synchronization message is generated, and add to a correction domain of the time synchronization message a complement of local counting time t1 at which the time synchronization message exits from the first time synchronization device;
the first time synchronization device is further arranged to determine local counting time t4 at which a delay request message is received, add to a correction domain of the delay request message a difference value between t4 and local counting time t3 at which the first service transport device receives the delay request message, generate a delay response message, add a fourth timestamp T4 at which the delay response message is generated and the correction domain of the delay request message to the delay response message, and send the delay response message to a slave device through the first service transport device; and
the first service transport device is arranged to receive the time synchronization message from the first time synchronization device, add, to the correction domain of the time synchronization message, local counting time t2 at which the time synchronization message exits from the first service transport device, and send the time synchronization message out; the first service transport device is further arranged to receive the time synchronization message which has been subjected to a correction performed by the slave device and includes a third timestamp T3, and send the local counting time t3 at which the delay request message is received as well as the delay request message to the first time synchronization device.

10. The master device according to claim 9, wherein the first time synchronization device and the first service transport device each comprises a local time counter; the local time counter of the first time synchronization device is arranged to generate the local counting time t1 and the local counting time t4, and the local time counter of the first service transport device is arranged to generate the local counting time t2 and the local counting time t3.

11. A slave device, comprising: a second time synchronization device and a second service transport device; wherein
the second service transport device is arranged to receive a time synchronization message which has been subjected to a correction performed by a master device and includes a first timestamp T1, send local counting time t5 at which the time synchronization message is received as well as the time synchronization message to the second time synchronization device; the second service transport device is further arranged to receive a delay request message from the second time synchronization device, add local counting time t8 at which the delay request message exits from the second service transport device to a correction domain of the time synchronization message, send the delay request message out, and receive a delay response message including a fourth timestamp T4 and a correction domain of the delay request message which has been subjected to a correction performed by the master device; and
the second time synchronization device is arranged to determine local counting time t6 at which the time synchronization message is received, add a difference value between t6 and t5 to the correction domain of the time synchronization message, and add to the time synchronization message a second timestamp T2 at which the time synchronization message is received; the second time synchronization device is further arranged to generate the delay request message, write into the delay request message a third timestamp T3 at which the delay request message is generated, add a complement of local counting time t7 at which the delay request message exits from the second time synchronization device to the correction domain of the delay request message, and perform time synchronization with the master device according to the T1, the T2, the T3, the T4, the correction domain of the time synchronization message and the correction domain of the delay request message.

12. The slave device according to claim 11, wherein the second time synchronization device and the second service transport device each comprises a local time counter; the local time counter of the second time synchronization device is arranged to generate the local counting time t6 and the local counting time t7, and the local time counter of the second service transport device is arranged to the local counting time t5 and the local counting time t8.

13. (canceled)

14. A computer storage medium, having stored therein computer executable instructions for implementing a method according to claim 1.

15. A computer storage medium, having stored therein computer executable instructions for implementing a method according to claim 5.
